(19) United States
(12) Patent Application Publication
(10) Pub. No.: US 2014/0293089 A1
(43) Pub. Date: Oct. 2, 2014

(54) IMAGE CAPTURING APPARATUS CAPABLE OF ADJUSTING WHITE BALANCE

(71) Applicant: CASIO COMPUTER CO., LTD., Tokyo (JP)

(72) Inventors: Hiroyasu Kitagawa, Tokyo (JP); Takeshi Tsukagoshi, Tokyo (JP)

(21) Appl. No.: 14/306,880

(22) Filed: Jun. 17, 2014

Related U.S. Application Data
(62) Division of application No. 13/288,137, filed on Nov. 3, 2011.

(30) Foreign Application Priority Data
Nov. 4, 2010 (JP) 2010-247802
Nov. 5, 2010 (JP) 2010-248677

(51) Int. Cl. H04N 9/73; H04N 5/235

(52) U.S. Cl. CPC H04N 9/735; H04N 5/2351; H04N 5/2354
USPC 348/224.1

(57) ABSTRACT

An image capturing apparatus includes an image capturing unit that acquires data of a first image captured with light and a second image captured without light, a white balance gain calculation unit that acquires gain values of each color component of the first and second images, an image partitioning unit that divides the first and second images into areas, a luminance acquisition unit that acquires luminance values for each area of the first and second images, a luminance acquisition unit that calculates relative values with respect to luminance values for each area of the first image and second image, and a luminance acquisition unit that selects specific relative values among the relative values. The white balance gain calculation unit corrects the gain value for each color component of the first image, based on the specific relative values.

This is a Divisional of U.S. application Ser. No. 13/288,137, filed Nov. 3, 2011, which is based on and claims the benefit of priority from Japanese Patent Application Nos. 2010-247802 and 2010-248677, respectively filed on Nov. 4, 2010, and Nov. 5, 2010, the entire contents of all of which are incorporated herein by reference.

### BACKGROUND OF THE INVENTION

1. Field of the Invention

The present invention relates to an image capturing apparatus, a white balance adjustment method and storage medium, and more particularly to a technique that can make color reproducibility of an image captured with a flash light more natural.

2. Related Art

Conventionally, white balance is adjusted so as to correct unnatural white color caused by a difference in color temperature when a flash light is flashed, in order to give a more natural color.

Japanese Patent Application Publication No. 1996-51632 discloses a white balance adjustment method that partitions an image captured with a flash light and an image captured without flash light respectively into a plurality of areas and sets a white balance for each partitioned area based on the luminance difference between corresponding areas.

### SUMMARY OF THE INVENTION

It is an object of the present invention to make color reproducibility of an image captured with a flash light more natural.

In order to attain the above-mentioned object, in accordance with a first aspect of the present invention, there is provided an image capturing apparatus, comprising:

a light emitting unit;

an image capturing unit;

an image acquisition unit that acquires a first image captured by the image capturing unit with light emitted by the light emitting unit, and a second image captured by the image capturing unit without the light emitted by the light emitting unit;

a gain value acquisition unit that acquires respective gain values for each color component of the first image and the second image;

a partitioning unit that partitions the first image and the second image unit into a plurality of areas;

a luminance acquisition unit that acquires respective luminance values for each area of the plurality of areas of the first image and the second image;

a calculation unit that calculates respective relative values based on the respective luminance values of the areas of the first image and the respective luminance values of corresponding areas of the second image, acquired by the luminance acquisition unit;

a selecting unit that selects a plurality of specific relative values from among the relative values; and

a correcting unit that corrects the gain values for each color component of at least one of the areas of the first image based on the plurality of specific relative values selected by the selecting unit.

The aforementioned image capturing apparatus may further comprise a conversion unit that converts each of the color component of the first image and the second image into a set of pixel parameters including luminance information in another color space. The correcting unit may further correct the gain value for each color component of the first image and the second image based on the set of pixel parameters converted by the conversion unit.

In order to attain the above-mentioned object, in accordance with a second aspect of the present invention, there is provided a white balance adjusting method, comprising:

an image acquisition step of acquiring a first image captured with emitted light, and a second image captured without emitted light;

a gain value acquisition step of acquiring respective gain values for each color component of the first image and the second image;

a partitioning step of partitioning the first image and the second image into a plurality of areas;

a luminance acquisition step of acquiring respective luminance values for each of the plurality of areas of the first image and the second image;

a calculation step of calculating respective relative values based on the respective luminance values of the areas of the first image and the respective luminance values of corresponding areas of the second image;

a selecting step of selecting a plurality of specific relative values preferentially from among the relative values; and

a correcting step of correcting the gain values for each color component of at least one of the areas of the first image based on the plurality of specific relative values selected in the selecting step.

In order to attain the above-mentioned object, in accordance with a third aspect of the present invention, there is provided a storage medium readable by a computer, the storage medium having stored therein a program causing the computer to implement:

an image acquisition function to acquire a first image captured with emitted light, and a second image captured without the emitted light;

a gain value acquisition function to acquire respective gain values for each color component of the first image and the second image;

a partitioning function to partition the first image and the second image into a plurality of areas;

a luminance acquisition function to acquire respective luminance values for each of the plurality of areas of the first image and the second image;

a calculation function to calculate respective relative values based on the respective luminance values of the areas of the first image and the respective luminance values of corresponding areas of the second image;

a selecting function to select a plurality of specific relative values preferentially from among the relative values; and

a correcting function to correct the gain values for each color component of at least one of the areas of the first image based on the plurality of specific relative values selected by the selecting function.

### BRIEF DESCRIPTION OF THE DRAWINGS

FIG. 1 is a block diagram showing a hardware configuration of one embodiment of an image capturing apparatus according to the present invention;

FIG. 2 is a flowchart showing flow of flash light image capture processing carried out by the image capturing apparatus having the hardware configuration shown in FIG. 1;

FIG. 3 is a view showing a frame format of a state in which 64 (8 by 8) partitioned areas are acquired from a live-view image without flash or an image captured with flash;

FIG. 4 is a diagram showing one example of a table that stores luminance ratios, for the partitioned areas, of the image captured with flash to the live-view image without flash;

FIG. 5 is a flowchart showing flow of a first embodiment of white balance processing carried out by the image capturing apparatus having the hardware configuration shown in FIG. 1; and

FIG. 6 is a flowchart showing flow of a second embodiment of white balance processing carried out by the image capturing apparatus having the hardware configuration shown in FIG. 1.

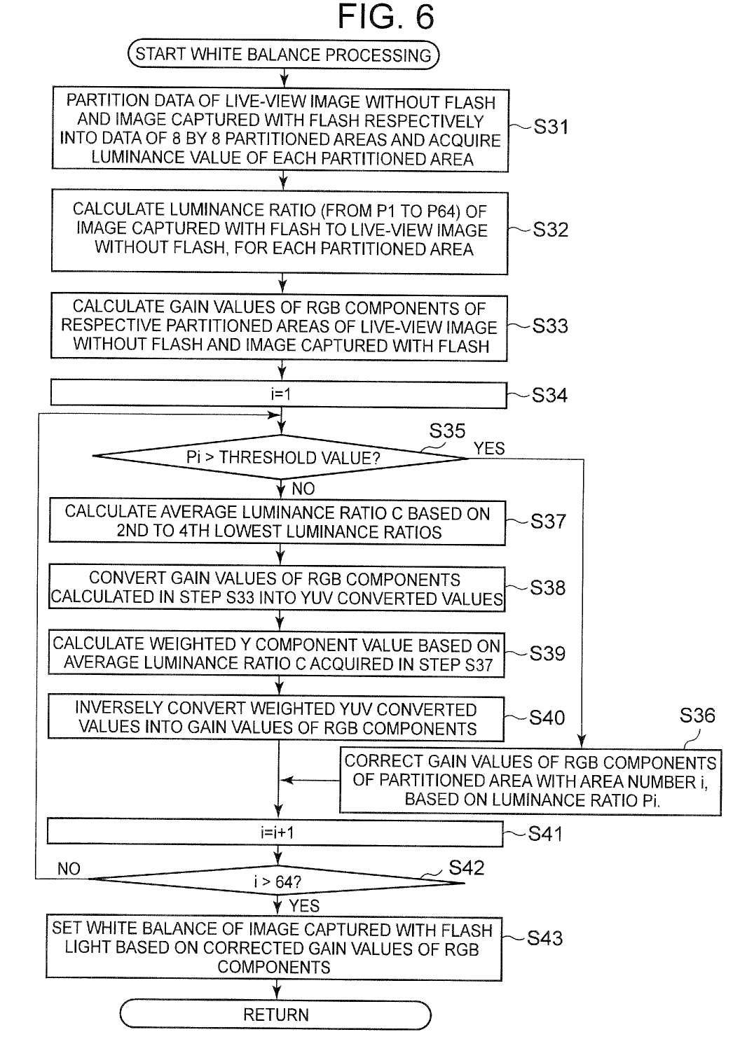

### DETAILED DESCRIPTION OF THE INVENTION

### First Embodiment

The following describes a first embodiment of the present invention with reference to the drawings.

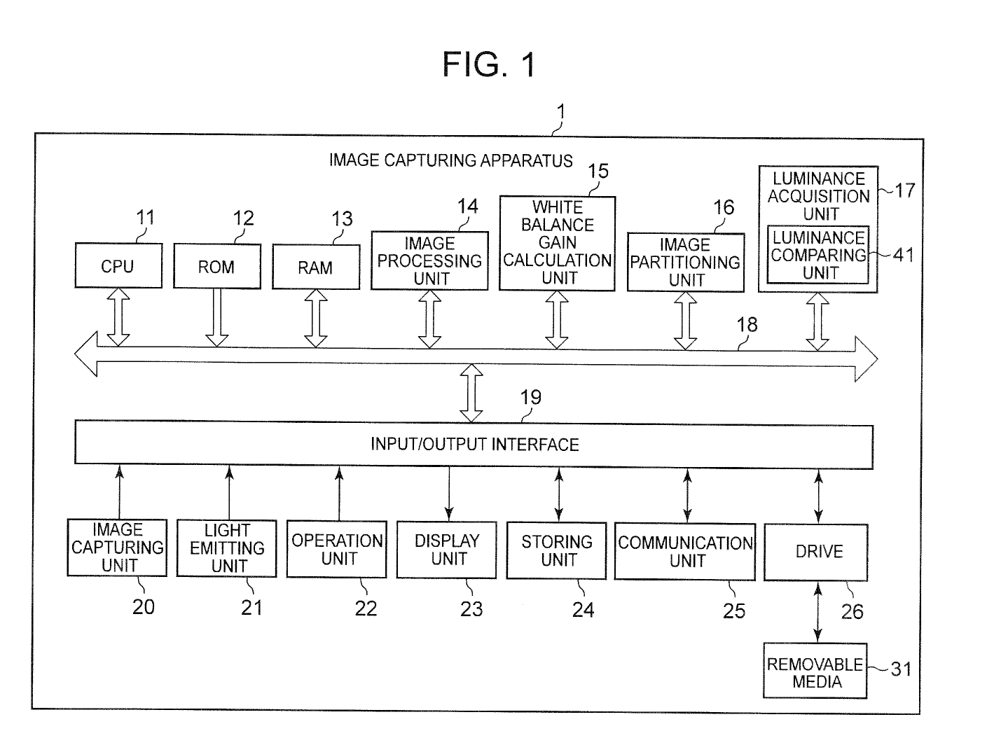

FIG. 1 is a block diagram showing a hardware configuration of one embodiment of an image capturing apparatus 1 according to the present invention.

The image capturing apparatus 1 shown in FIG. 1 can be configured by a digital camera, for example.

The image capturing apparatus 1 is provided with a CPU (Central Processing Unit) 11, a ROM (Read Only Memory) 12, a RAM (Random Access Memory) 13, an image processing unit 14, a white balance gain calculation unit 15, an image partitioning unit 16, a luminance acquisition unit 17, a bus 18, an input/output interface 19, an image capturing unit 20, a light emitting unit 21, an operation unit 22, a display unit 23, a storing unit 24, a communication unit 25, and a drive 26.

The CPU 11 executes various processes according to programs that are stored in the ROM 12 or programs that are loaded from the storing unit 24 to the RAM 13.

The RAM 13 also stores data and the like, necessary for the CPU 11 to execute the various processes, as appropriate.

The image processing unit 14 is configured by a DSP (Digital Signal Processor), a VRAM (Video Random Access Memory), and the like, and collaborates with the CPU 11 to execute various kinds of image processing on image data.

For example, the image processing unit 14 executes image processing such as noise reduction, white balance adjustment, anti-shaking, and the like, on data of a captured image outputted from the image capturing unit 20, which will be described later.

The white balance gain calculation unit 15 computes white balance gains to be used for white balance adjustment from among the various types of image processing executed by the image processing unit 14. A detailed description will be given later of the white balance gain calculation unit 15.

The image partitioning unit 16 partitions image data to be used for white balance adjustment from among the various types of image processing executed by the image processing unit 14 into image data of several areas in the space dimension. A detailed description will be given later of the image partitioning unit 16.

The luminance acquisition unit 17 acquires luminance values and the like from image data to be used for white balance adjustment from among the various types of image processing executed by the image processing unit 14. A detailed description will be given later of the luminance acquisition unit 17 along with a luminance comparing unit 41.

The CPU 11, the ROM 12, the RAM 13, the image processing unit 14, the white balance gain calculation unit 15, the image partitioning unit 16, and the luminance acquisition unit 17 are connected to one another via the bus 18. The bus 18 is also connected with the input/output interface 19. The input/output interface 19 is connected to the image capturing unit 20, the light emitting unit 21, the operation unit 22, the display unit 23, the storing unit 24, the communication unit 25, and the drive 26.

The image capturing unit 20 is provided with an optical lens unit and an image sensor, which are not shown.

The optical lens unit is configured by a light condensing lens such as a focus lens, a zoom lens, and the like, for example, to photograph a subject.

The focus lens is a lens for forming an image of a subject on the light receiving surface of the image sensor. The zoom lens is a lens for freely changing a focal point within a predetermined range.

The optical lens unit also includes peripheral circuits to adjust parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes various kinds of signal processing such as A/D (Analog/Digital) conversion of the analog signal and outputs the resultant digital signal as an output signal from the image capturing unit 20.

Hereinafter, the output signal from the image capturing unit 20 is referred to as “data of a captured image”. Thus, data of a captured image is outputted from the image capturing unit 20 and provided as appropriate to the CPU 11, the image processing unit 14, the image partitioning unit 15, the white balance gain calculation unit 15, and the like.

The light emitting unit 21 includes a flash light that flashes under the control of the CPU 11. In the first embodiment, the flash light flashes when a user operates the operation unit 22 to instruct a recording of a captured image, e.g., when a user presses a shutter button (not shown) of the operation unit 22.

The operation unit 22 is configured by various buttons such as the shutter button (not shown) and the like, and accepts an instruction from a user.

The display unit 23 is configured by a display and the like, which is capable of displaying various images.

The storing unit 24 is configured by a DRAM (Dynamic Random Access Memory) or the like, and stores data of various images such as a live-view image, which will be described later, an original image to be displayed, and an image to be combined with the original image.

The communication unit 25 controls communication with other devices (not shown) via a network including the Internet.

Removable media 31 such as a magnetic disk, an optical disk, a magneto-optical disk, or a semiconductor memory is mounted to the drive 26, as appropriate. Also, programs read via the drive 26 from the removable media 31 are installed in the storing unit 24 as necessary. Furthermore, similar to the storing unit 24, the removable media 31 can store various kinds of data such as image data and the like, stored in the storing unit 24.

In the above, a description has been given of the hardware configuration of the image capturing apparatus 1 of the first embodiment with reference to FIG. 1.

In the following, a description will be given of flow of flash light image capture processing carried out by the image capturing apparatus 1 having such a hardware configuration. The flash light image capture processing is intended to mean a series of processes from capturing an image of a subject with the flash light, adjusting white balance of the resultant data of the captured image, to storing it in the removable media 31 or the like.

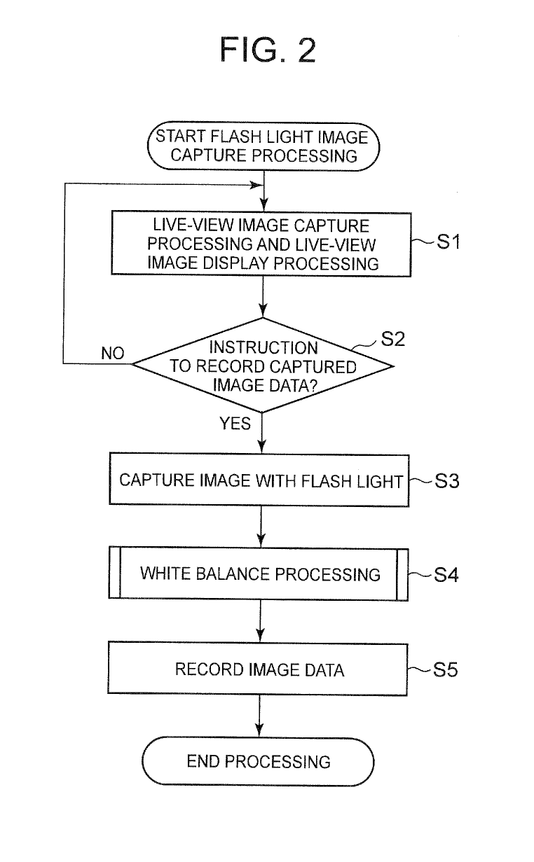

FIG. 2 is a flowchart showing flow of the flash light image capture processing carried out by the image capturing apparatus 1 having the hardware configuration shown in FIG. 1.

In the first embodiment, it is assumed that the image capturing apparatus 1 has two operation modes including a normal mode of capturing an image of a subject without flash light and a flash mode of capturing an image of a subject with flash light. It is also assumed that a user can selectively designate the normal mode and the flash mode by performing a predetermined operation of the operation unit 22.

The flash light image capture processing starts when the user designates selection of the flash mode.

In step S1, the CPU 11 executes live-view image capture processing and live-view image display processing.

This means that the CPU 11 controls the image capturing unit 20 and the image processing unit 14 to continuously carry out the image capturing operation by the image capturing unit 20. While the image capturing operation is continuously carried out by the image capturing unit 20, the CPU 11 temporarily stores the data of the captured images sequentially outputted from the image capturing unit 20 in a memory (the storing unit 24). Such a series of processes is referred to as “live-view image capture processing”.

Also, the CPU 11 sequentially reads the data of each captured image temporarily stored in the memory (the storing unit 24) at the time of the live-view image capture processing and causes the display unit 23 to sequentially display each captured image based on the data. Such a series of processes is referred to as “live-view image display processing”. Hereinafter, a captured image that is displayed on the display unit 23 by the live-view image display processing is referred to as a “live-view image”.

In step S2, the CPU 11 determines whether or not an instruction has been given to record the data of the captured image.

As described above, the user can designate recording of the data of the captured image by pressing down the shutter button of the operation unit 22.

Therefore, if the shutter button is not pressed down, a determination of NO is made in step S2 and control goes back to step S1. This means that, until the shutter button is pressed down, the loop processing in steps S1 and S2 is repeated, thereby the live-view image capture processing and the live-view image display processing are repeatedly executed, and the live-view image of a subject is continuously displayed on the display unit 23 in real-time.

It is to be noted that, though not illustrated, in a case in which the shutter button has not been pressed for a predetermined time, the CPU 11 or the like may forcibly terminate the flash light image capture processing.

Thereafter, when the shutter button is pressed down, a determination of YES is made in step S2, and control proceeds to step S3.

In step S3, the CPU 11 performs control to capture an image of a subject with the flash light. More specifically, the CPU 11 controls the light emitting unit 21 to emit the flash light and controls the image capturing unit 20 so as to capture an image of a subject.

At this time, the data of the captured image outputted from the image capturing unit 20 is temporarily stored in the storing unit 24 as the data to be recorded.

In step S4, the CPU 11 executes processing of adjusting the white balance of the captured image to be recorded, using the data of the live-view image of a subject captured without the flash light in the live-view image capture processing in step S1 and the data of the captured image of the subject captured with the flash light in the process of step S3.

Hereinafter, such processing in step S4 is referred to as “white balance processing” in accordance with the description of FIG. 2. Also, the data of a live-view image of a subject captured without the flash light in the live-view image capture processing in step S1 is hereinafter referred to as “data of a live-view image without flash”. The data of a captured image of a subject captured with the flash light in the process of step S3 is hereinafter referred to as “data of an image captured with flash”.

Here, it is assumed that the data of the image captured with flash is employed as the data of the captured image to be recorded. However, in place of the data of the aforementioned image captured with flash, data of an image that is captured by the image capturing unit 20 again with the flash light after the white balance has been set may be employed as the captured image to be recorded. In this case, the data of the captured image to be recorded is adjusted with the white balance thus set.

A detailed description will be given later of the white balance processing.

In step S5, the CPU 11 stores in the removable media 31 the data of the captured image to be recorded, on which the white balance processing has been executed in the process of step S4.

With this, the flash light image capture processing ends.

In the above, a description has been given of the flash light image capture processing.

In the following, a description will be given of the white balance processing executed in step S4 from among processes of the flash light image capture processing.

First, a description will be given of a functional configuration to carry out the white balance processing. Next, a description will be given of flow of the white balance processing carried out based on such a functional configuration.

When the white balance processing is executed, the white balance gain calculation unit 15, the image partitioning unit 16, and the luminance acquisition unit 17 are operated from among the constituent elements of the image capturing apparatus 1 shown in FIG. 1.

The white balance gain calculation unit 15 calculates white balance gains for data of the live-view image without flash and data of the image captured with flash respectively.

More specifically, it is assumed that data of the live-view image without flash and the data of the image captured with flash are constituted by RGB (R: Red, G: Green, B: Blue) components.

Consequently, the white balance calculation unit 15 calculates, as white balance gains of the live-view image without flash, the R component gain (hereinafter, referred to as “SRG”), the G component gain (hereinafter, referred to as “SGG”), and the B component gain (hereinafter, referred to as “SBG”). Also hereinafter, SRG, SGG, and SBG are inclusively referred to as “gain values of the RGB components of the live-view image without flash”.

Also, the white balance gain calculation unit 15 calculates, as white balance gains of the image captured with flash, the R component gain (hereinafter, referred to as “LRG”), the G component gain (hereinafter, referred to as “LGG”), and the B component gain (hereinafter, referred to as “LBG”). Hereinafter, LRG, LGG, and LBG are inclusively referred to as “gain values of the RGB components of the image captured with flash”.

The white balance gain calculation unit 15 converts the gain values of the RGB components of the live-view image without flash and the image captured with flash into gain values of YUV (Y: luminance, U: difference between luminance and blue component, V: difference between luminance and red component) components.

Hereinafter, the gain values of the YUV components converted from the gain values of the RGB components of the live-view image without flash and the image captured with flash are referred to as “YUV converted values”.

Here, the YUV converted values of the live-view image without flash are constituted by the Y component gain (hereinafter, referred to as “SY”), the U component gain (hereinafter, referred to as “SU”), and the V component gain (hereinafter, referred to as “SV”).

In this case, the YUV converted values of the live-view image without flash are calculated from the following equation (1).

$$\begin{matrix}[ Math . 1 ] & \\ ( \begin{matrix}a 11 & & \\ & ⋱ & \\ & & a 33\end{matrix} ) ( \begin{matrix}SRG \\ SGG \\ SBG\end{matrix} ) = ( \begin{matrix}SY \\ SU \\ SV\end{matrix} ) & ( 1 )\end{matrix}$$

The 3 by 3 matrix to be multiplied from the left on the left-hand side of equation (1), i.e., the matrix having elements aij (i and j are mutually independent integers between 1 and 3) is a conversion matrix that converts the RGB components into the YUV components.

On the other hand, the YUV converted values of the image captured with flash are constituted by the Y component gain (hereinafter, referred to as “LY”), the U component gain (hereinafter, referred to as “LU”), and the V component gain (hereinafter, referred to as “LV”).

In this case, the YUV converted values of the image captured with flash are calculated from the following equation (2).

$$\begin{matrix}[ Math . 2 ] & \\ ( \begin{matrix}a 11 & & \\ & ⋱ & \\ & & a 33\end{matrix} ) ( \begin{matrix}LRG \\ LGG \\ LBG\end{matrix} ) = ( \begin{matrix}LY \\ LU \\ LV\end{matrix} ) & ( 2 )\end{matrix}$$

Next, the white balance gain calculation unit 15 corrects the Y component gain LY from among the YUV converted values of the image captured with flash, in view of the overall luminance ratio, for each partitioned area, of the image captured with flash to the live-view image without flash. Descriptions of the partitioned areas and the luminance ratios will be given later.

Hereinafter, from among the YUV converted values of the image captured with flash, the Y component gain after being corrected is referred to as “LY′”. This means that LY′ is the value of LY weighted in view of the overall luminance ratio, for each partitioned area, of the image captured with flash to the live-view image without flash.

For example, LY′ is acquired in accordance with the following equation (3).

$$\begin{matrix}[ Math . 3 ] & \\ {LY}^{′} = SY \times \frac{1}{C} + LY \times \frac{C - 1}{C} & ( 3 )\end{matrix}$$

In equation (3), C is a variable coefficient to be used for weighting in view of the overall luminance ratio, for each partitioned area, of the image captured with flash to the live-view image without flash, and is an average luminance ratio calculated by the luminance comparing unit 41, which will be described later.

Next, the white balance gain calculation unit 15 inversely converts the YUV converted values of the image captured with flash, the Y component of which has been corrected (weighted) in accordance with equation (3), into the gain values of the RGB components. More specifically, the white balance gain calculation unit 15 acquires the gain values of the RGB components of the image captured with flash after the inverse conversion in accordance with the following equation (4).

$$\begin{matrix}[ Math . 4 ] & \\ {( \begin{matrix}a 11 & & \\ & ⋱ & \\ & & a 33\end{matrix} )}^{- 1} ( \begin{matrix}{LY}^{′} \\ LU \\ LV\end{matrix} ) = ( \begin{matrix}LR α \\ LG α \\ LB α\end{matrix} ) & ( 4 )\end{matrix}$$

The column vector on the right-hand side of equation (4) denotes the gain values of the RGB components of the image captured with flash after the inverse conversion. The gain values of the RGB components of the image captured with flash after the inverse conversion are constituted by the R component gain after the inverse conversion (hereinafter, referred to as “LRα” in consideration of the description of equation (4)), the G component gain after the inverse conversion (hereinafter, referred to as “LGα” in consideration of the description of equation (4)), and the B component gain after the inverse conversion (hereinafter, referred to as “LBα” in consideration of the description of equation (4)).

On the left-hand side of equation (4), the matrix to be multiplied from the left is the inverse matrix of the conversion matrix used in equations (1) and (2).

The white balance gain calculation unit 15 sets the white balance of the captured image to be recorded based on the gain values of the RGB components of the image captured with flash after the inverse conversion.

In the following, a description will be given of the functional configuration when the image capturing apparatus 1 carries out processing of calculating the average luminance ratio C used in the above described equation (3) as part of the white balance processing. Here, the image partitioning unit 16 and the luminance acquisition unit 17 operate.

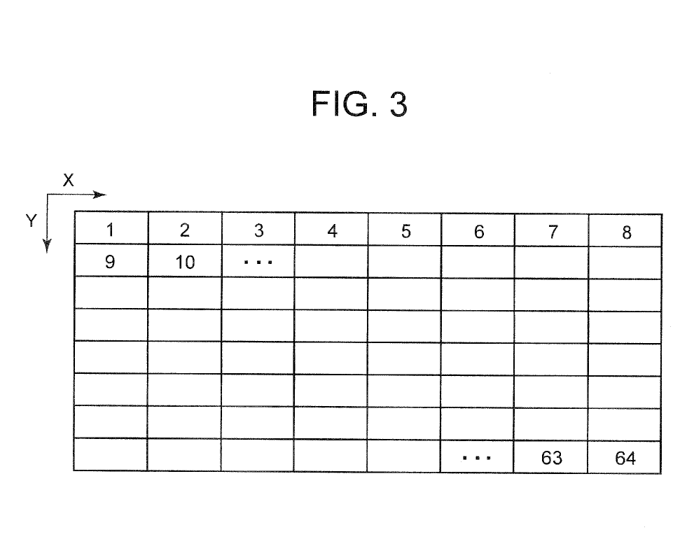

The image partitioning unit 16 partitions the data of the live-view image without flash and the data of the image captured with flash into data of 64 (8 by 8) areas, respectively, as shown in FIG. 3.

In the present specification, such areas partitioned by the image partitioning unit 16 are referred to as “partitioned areas”.

FIG. 3 is a view showing a frame format of a state in which 64 (8 by 8) partitioned areas are acquired from the live-view image without flash or the image captured with flash.

As shown in FIG. 3, each partitioned area is numbered with a uniquely identifiable number, more specifically, 1, 2, 3, 4, 5, 6, 7, 8, 9, 10, . . . , 63, and 64 from the left uppermost partitioned area horizontally rightward and then vertically downward. Hereinafter, the number assigned to a partitioned area is referred to as an “area number”.

Since the area numbers are uniformly assigned to the partitioned areas of both the live-view image without flash and the image captured with flash, the partitioned areas with the same area number for the live-view image without flash and the image captured with flash are identical in position, size, and range, with respect to an entire image.

The data of each partitioned area, for example, is managed by being stored in the storing unit 24 in association with the assigned area number in a table format.

The luminance acquisition unit 17 acquires luminance values both from the data of the live-view image without flash and the data of the image captured with flash in units of partitioned areas.

Here, since each of the partitioned areas is constituted by a plurality of pixels, the luminance of a partitioned area is assumed to be a value calculated based on the luminance of each constituent pixel of the partitioned area, e.g., an average value of the luminance of each partitioned area.

The luminance acquisition unit 17 is provided with the luminance comparing unit 41.

The luminance comparing unit 41 calculates the luminance ratio of the image captured with flash to the live-view image without flash for each partitioned area.

The luminance ratio Ck for an area number k (k is a positive integer less than or equal to the number of partitioned areas, i.e., a positive number less than or equal to 64) is acquired in accordance with the following equation (5).

$$\begin{matrix}[ Math . 5 ] & \\ Ck = \frac{{Yk}^{′}}{Yk} & ( 5 )\end{matrix}$$

In equation (5), Yk′ denotes the luminance of the k-th partitioned area of the image captured with flash, and Yk denotes the luminance of the k-th partitioned area of the live-view image without flash.

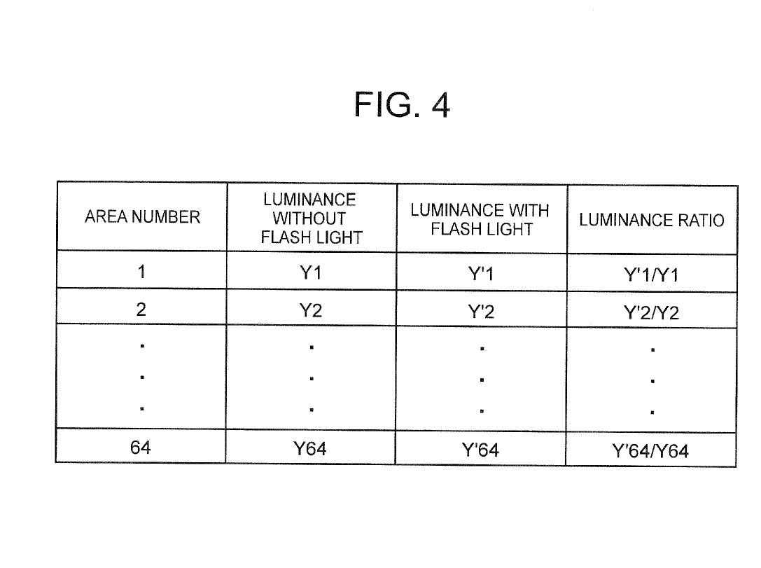

The calculation result of equation (5) by the luminance comparing unit 41 is stored in the storing unit 24 and managed in the table format shown in FIG. 4, for example.

FIG. 4 shows one example of the table storing the luminance ratio, for each partitioned area, of the image captured with flash to the live-view image without flash.

Since the table shown in FIG. 4 has a matrix structure, hereinafter, a set of items in a horizontal line shown in FIG. 4 is referred to as a “row”, and a set of items in a vertical line shown in FIG. 4 is referred to as a “column”. Each row is associated with a predetermined area number. This means that each row has items of “area number”, “luminance without flash light”, “luminance with flash light”, and “luminance ratio” for the area number corresponding to the row.

The item “area number” in the k-th row from the top (excluding the top row of FIG. 4, which shows the names of the items; the same applies to the rest) contains the area number k.

The item “luminance without flash light” in the k-th row contains the luminance Yk of the k-th partitioned area of the live-view image without flash.

The item “luminance with flash light” in the k-th row contains the luminance Yk′ of the k-th partitioned area of the image captured with flash.

The item “luminance ratio” in the k-th row contains the k-th luminance ratio Ck, i.e., the calculation result of equation (5).

Next, the luminance comparing unit 41 sorts the luminance ratio for each partitioned area in decreasing order.

Then, the luminance comparing unit 41 acquires the average value of the 2nd to 4th highest luminance ratios from among the luminance ratios of the partitioned areas sorted in the decreasing order as the aforesaid average luminance ratio C.

More specifically, the luminance comparing unit 41 acquires the average luminance ratio C by calculating the following equation (6).

$$\begin{matrix}[ Math . 6 ] & \\ C = \frac{Ct 2 + Ct 3 + Ct 4}{3} & ( 6 )\end{matrix}$$

In equation (6), items Ct2 to Ct4 respectively denotes the 2nd to 4th highest luminance ratios.

For example, it is assumed that the highest 4 luminance ratios from among the luminance ratios (C1=Y1′/Y1, C2=Y2′/Y2, C3=Y3′/Y3, . . . , C8=Y8′/Y8, . . . , C22=Y22′/Y22, . . . , C64=Y64′/Y64) of the entire partitioned areas are as follows.

The 1st is Ct1=C1=Y1′/Y1;

the 2nd is Ct2=C2=Y2′/Y2;

the 3rd is Ct3=C8=Y8′/Y8; and

the 4th is Ct4=C22=Y22′/Y22.

In this case, the average luminance ratio C is calculated in accordance with the following equation (7).

$$\begin{matrix}[ Math . 7 ] & \\ C = \frac{Y {2}^{′} / Y 2 + Y {8}^{′} / Y 8 + Y {22}^{′} / Y 22}{3} & ( 7 )\end{matrix}$$

The average luminance ratio C thus acquired is substituted into the above-mentioned equation (3) as a coefficient.

In the above, a description has been given of the functional configuration to carry out the white balance processing in step S4 of FIG. 2 from the functional configuration of the image capturing apparatus 1 of FIG. 1 with reference to FIGS. 3 and 4.

In the following, a description will be given of a detailed flow of the white balance processing in step S4 carried out by the image capturing apparatus 1 having such a functional configuration.

In the white balance processing, under the control of the CPU 11, either of the white balance gain calculation unit 15, the image partitioning unit 16, and the luminance acquisition unit 17 executes the process of each step. In the following, descriptions of the control of the CPU 11 will be omitted.

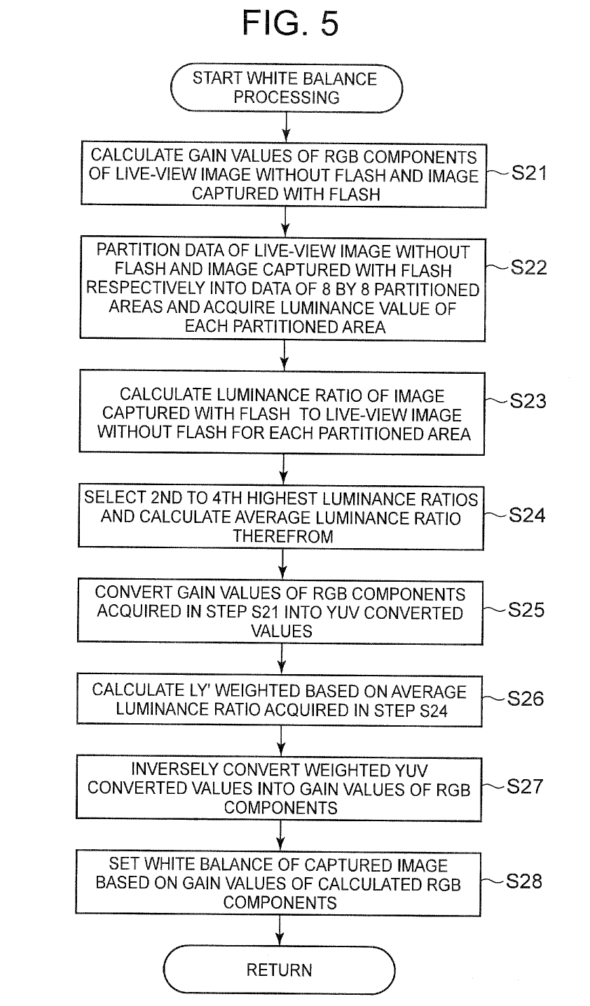

FIG. 5 is a flowchart showing a detailed flow of the white balance processing in step S4 from the flash light image capture processing of FIG. 2 carried out by the image capturing apparatus 1 of FIG. 1.

In step S21, the white balance gain calculation unit 15 calculates gain values of the RGB components of the live-view image without flash and gain values of the RGB components of the image captured with flash.

More specifically, the white balance gain calculation unit 15 respectively calculates the R component gain SRG, the G component gain SGG, and the B component gain SBG as the white balance gains of the live-view image without flash.

Similarly, the white balance gain calculation unit 15 respectively calculates the R component gain LRG, the G component gain LGG, and the B component gain LBG as the white balance gains of the image captured with flash.

In step S22, the image partitioning unit 16 and the luminance acquisition unit 17 partition the image captured with flash and the live-view image without flash into 8 by 8 partitioned areas respectively, and calculate luminance value for each partitioned area for each image.

More specifically, the image partitioning unit 16 firstly partitions the data of the live-view image without flash and the image captured with flash respectively into data of a plurality of partitioned areas, e.g., 64 (8 by 8) partitioned areas as shown in FIG. 3.

Then, the luminance acquisition unit 17 acquires the luminance value for each partitioned area from the data of the live-view image without flash and the image captured with flash.

In step S23, the luminance comparing unit 41 calculates the luminance ratio, for each partitioned area, of the image captured with flash to the live-view image without flash. More specifically, the luminance comparing unit 41 calculates the luminance ratio by calculating the above described equation (5). The calculation result of equation (5) by the luminance comparing unit 41 is stored in the storing unit 24 and managed in the table format shown in FIG. 4, for example.

In step S24, the luminance comparing unit 41 selects the 2nd to 4th highest luminance ratios and calculates an average of the luminance ratios (average luminance ratio). This means that the luminance comparing unit 41 sorts the luminance ratio for each of the partitioned areas in decreasing order. Then, the luminance comparing unit 41 calculates the above described equation (6), and thereby acquires the average luminance ratio C, which is the average value of the 2nd to 4th highest luminance ratios from among the luminance ratios sorted in the decreasing order, for each partitioned area.

In step S25, the white balance gain calculation unit 15 converts the gain values of the RGB components acquired in step S21 into the YUV converted values. More specifically, the white balance gain calculation unit 15 operates the above described equations (1) and (2), and thereby converts the gain values of the RGB components of the live-view image without flash and the image captured with flash acquired in step S21 into the YUV converted values.

In step S26, the white balance gain calculation unit 15 calculates a Y component gain (LY′) based on the average luminance ratio C acquired in step S24. More specifically, the white balance gain calculation unit 15 operates the above described equation (3) based on the average luminance ratio C calculated in step S24, and thereby corrects the Y component gain LY to LY′ from among the YUV converted values of the image captured with flash, in view of overall luminance ratios of each partitioned area of the image captured with flash and the live-view image without flash.

In step S27, the white balance gain calculation unit 15 inversely converts the weighted YUV converted values into gain values of the RGB components. More specifically, the white balance gain calculation unit 15 calculates gain values of the RGB components of the image captured with flash after the inverse conversion in accordance with the above described equation (4).

In step S28, the white balance gain calculation unit 15 sets a white balance of the captured image based on the gain values of the RGB components thus calculated. This means that the white balance gain calculation unit 15 sets the white balance of the captured image to be recorded based on the gain values of the RGB components of the image captured with flash after the inverse conversion. In this manner, the white balance processing is terminated, and control goes back to the flash light image capture processing and proceeds to step S5 of FIG. 2.

As described above, the image capturing apparatus 1 is provided with a light emitting unit 21, an image capturing unit 20, a CPU 11, a white balance gain calculation unit 15, an image partitioning unit 16, a luminance acquisition unit 17, and a luminance comparing unit 41.

In response to a user's operation, the CPU 11 executes a control of causing the image capturing unit 20 to capture an image captured with flash (image captured with flash), which is an image captured at a time when illuminated by emission from the light emitting unit 21, and a live-view image (live-view image without flash), which is an image captured at a time when not illuminated by emission from the light emitting unit 21.

The white balance gain calculation unit 15 calculates and acquires a gain value of each color component for adjusting the white balance, which has been set when the image captured with flash and the live-view image without flash are captured.

The image partitioning unit 16 partitions the image area captured by the image capturing unit 20 into a plurality of areas.

The luminance acquisition unit 17 calculates the luminance values of the plurality of areas partitioned by the image partitioning unit 16 respectively for the image captured with flash and the live-view image without flash.

The luminance comparing unit 41 calculates a relative value acquired by dividing a luminance value of each area of the image captured with flash calculated by the luminance acquisition unit 17 by the luminance value of a corresponding area of the live-view image without flash.

The luminance comparing unit 41 preferentially selects a plurality of relative values of higher values from among the relative values calculated by the luminance comparing unit 41.

The white balance gain calculation unit 15 corrects the gain value of each color component of the image captured with flash, which has been captured when illuminated by the emission from the light emitting unit 21, based on the calculated gain values of each color component of the image captured with flash and the live-view image without flash and the plurality of relative values selected by the luminance comparing unit 41.

In the image capturing apparatus 1 thus configured, it is possible to enhance natural color reproducibility of an image captured with a flash light.

Also, the white balance gain calculation unit 15 converts the acquired RGB components of the image captured with flash and the live-view image without flash into another color space of, for example, a set of pixel parameters (such as YUV converted values) including at least luminance information.

Furthermore, the white balance gain calculation unit 15 corrects the gain values of the RGB components based on the converted set of pixel parameters (YUV converted values).

In the image capturing apparatus 1 thus configured, since the luminance is adjusted in level of the gray balance by way of the conversion into the YUV converted values, it is possible to reduce a change in a specific color, which could be caused when the luminance of an image captured with a flash light is separately adjusted in each color component thereof. Therefore, it is possible to further enhance natural color reproducibility of an image.

It should be noted that the present invention is not limited to the embodiment described above, and any modifications and improvements thereto within the scope that can realize the object of the present invention are included in the present invention.

Although, in the embodiment described above, the luminance ratio Ck has been acquired in accordance with the above-mentioned equation (5), the present invention is not limited thereto. For example, the luminance ratio Ck may be acquired in accordance with the following equation (8). In this case, the 2nd to 4th lowest luminance ratios are used to calculate the average luminance ratio Ck.

$$\begin{matrix}[ Math . 8 ] & \\ Ck = \frac{Yk}{{Yk}^{′}} & ( 8 )\end{matrix}$$

Furthermore, in the embodiment described above, although the 2nd to 4th highest luminance ratios is used to calculate the average luminance ratio, the present invention is not limited thereto. The luminance ratios to be used to calculate the average luminance ratio may be any luminance ratios as long as they are of relatively higher values from among the all of the luminance ratios.

Furthermore, in the embodiment described above, although it has been described that the highest luminance ratio is not used, the present invention is not limited thereto. The highest luminance ratio may also be used if the highest luminance ratio is not an unstable value such as an extremely high value in comparison with other luminance ratios.

Furthermore, in the embodiment described above, although it has been described that the live-view image without flash and the image captured with flash are respectively partitioned into 64 (8 by 8) partitioned areas as shown in FIG. 3, the present invention is not limited thereto. As long as the images are partitioned into a plurality of areas, the number, size, or the like of areas may be determined in any manner as appropriate.

Furthermore, in the embodiment described above, although it has been described that the data of the image captured with flash and the live-view image without flash captured by the image capturing unit 20 is employed to execute the white balance processing, the present invention is not limited thereto. For example, data of any captured image and any live-view image acquired from outside via CPU 11 or the image processing unit 14 may be employed. Also, in the embodiment described above, although it has been described that the data of the image captured with flash and the live-view image without flash is employed to execute the white balance processing, the present invention is not limited thereto. For example, data of an image captured with flash and an image captured without flash may be employed to execute the white balance processing.

### Second Embodiment

The following describes a second embodiment of the present invention with reference to the drawings.

The second embodiment is different from the first embodiment in the white balance processing in step S4 of FIG. 2. Therefore, as the description of the second embodiment, the white balance processing executed in step S4 will be described hereinafter.

When the white balance processing is carried out, from among the constituent elements of the image capturing apparatus 1 shown in FIG. 1, the white balance gain calculation unit 15, the image partitioning unit 16, and the luminance acquisition unit 17 are operated.

The white balance gain calculation unit 15 corrects gain values of the RGB components of the image captured with flash for each of the plurality of partitioned areas.

Here, in the second embodiment, the plurality of partitioned areas are classified into a group of partitioned areas (hereinafter, referred to as “illuminated areas”) estimated to be sufficiently illuminated by the flash light and a group of partitioned areas other than the illuminated areas (hereinafter, referred to as “unilluminated areas”). The method of classifying into the groups of the illuminated areas and the unilluminated areas will be described later.

In the second embodiment, it is assumed that the method of correcting the gain values of the RGB components of the image captured with flash is different depending on whether the areas are the illuminated areas and the unilluminated areas.

In the following, a description will be given of the method of correcting the gain values of the RGB components of the unilluminated areas of the image captured with flash.

Even in an unilluminated area, it is unlikely that the flash light does not illuminate at all. Accordingly, it is necessary to adjust the white balance in view of the flash light illumination. In order to enable such adjustment, the gain values of the RGB components of the unilluminated areas of the image captured with flash are corrected in a manner described hereinafter.

The white balance gain calculation unit 15 converts the gain values of the RGB components of the unilluminated areas of the image captured with flash and the live-view image without flash into gain values of YUV (Y: luminance, U: difference between luminance and blue component, V: difference between luminance and red component) components.

Hereinafter, the gain values of the YUV components converted from the gain values of the RGB components of the live-view image without flash and the image captured with flash are referred to as “YUV converted values” similarly to the first embodiment.

Then, the white balance gain calculation unit 15 corrects the Y component gain LY from among the YUV converted values of the unilluminated areas of the image captured with flash, in view of the overall luminance ratios of the unilluminated areas between the image captured with flash and the live-view image without flash, which will be described later.

Hereinafter, the Y component gain after being corrected from among the YUV converted values of the unilluminated areas of the image captured with flash is referred to as “LY′”. This means that LY′ is a value of LY, weighted in view of the overall luminance ratios of the unilluminated areas between the image captured with flash and the live-view image without flash.

For example, LY′ is acquired by equation (3) similarly to the first embodiment.

The white balance gain calculation unit 15 inversely converts the YUV converted values of the unilluminated areas of the image captured with flash, the Y component of which has been corrected (weighted) by equation (3) into the gain values of the RGB components. More specifically, the white balance gain calculation unit 15 acquires the gain values of the RGB components of the unilluminated areas of the image captured with flash after the inverse conversion in accordance with equation (4) of the first embodiment.

The column vector in the right-hand side of equation (4) denotes the gain values of the RGB components of the unilluminated areas of the image captured with flash after the inverse conversion. The gain values of the RGB components of the unilluminated areas of the image captured with flash after the inverse conversion are constituted by the R component gain after the inverse conversion “LRα”, the G component gain after the inverse conversion “LGα”, and the B component gain after the inverse conversion “LBα”.

Thus, the gain values of the RGB components of the unilluminated areas of the image captured with flash are corrected.

In the above, a description has been given of the method of correcting the gain values of the RGB components of the unilluminated areas of the image captured with flash.

Although the method of correcting the gain values of the RGB components of the illuminated areas for the image captured with flash is not limited, it is assumed that the second embodiment employs a correcting method based on a luminance ratio, which will be described later.

The white balance gain calculation unit 15 sets the white balance of the captured image to be recorded for each partitioned area based on the gain values after correction of the RGB components of each partitioned area of the image captured with flash.

As described above, in the processing by the white balance gain calculation unit 15, the luminance ratio is required for each partitioned area similar to the first embodiment. The luminance acquisition unit 17 is provided to perform the calculations such as of the luminance ratio.

The luminance acquisition unit 17 acquires a luminance value for each partitioned area from the data of the live-view image without flash and the image captured with flash.

Here, since each of the partitioned areas is constituted by a plurality of pixels, the luminance of a partitioned area is assumed to be a value calculated based on the luminance of each constituent pixel of the partitioned area, e.g., an average value of the luminance of the respective pixels.

The luminance acquisition unit 17 is provided with the luminance comparing unit 41.

The luminance comparing unit 41 calculates the luminance ratio of the image captured with flash to the live-view image without flash for each partitioned area.

The luminance ratio Pi for the area number i (i is a positive integer less than or equal to the number of partitioned areas, i.e., 64 in the second embodiment) is acquired in accordance with the following equation (9).

$$\begin{matrix}[ Math . 9 ] & \\ Pi = \frac{{Yi}^{′}}{Yi} & ( 9 )\end{matrix}$$

In equation (9), Yi′ denotes the luminance of the i-th partitioned area of the image captured with flash, and Yi denotes the luminance of the i-th partitioned area of the live-view image without flash.

In the second embodiment, the calculation result of equation (9) by the luminance comparing unit 41 is stored in the storing unit 24 and managed in the table format shown in FIG. 4, for example.

In the second embodiment, each partitioned area is classified into either an illuminated area or an unilluminated area, based on the luminance ratio thus acquired for each partitioned area. More specifically, in the second embodiment for example, a value, which is appropriate as the lowest limit of the luminance ratio to be acquired when sufficiently illuminated by the flash light, is specified as a threshold value in advance. In this case, the i-th partitioned area is classified into an unilluminated area if the luminance ratio Pi does not exceed the threshold value. On the other hand, the i-th partitioned area is classified into an illuminated area if the luminance ratio Pi exceeds the threshold value.

Next, the luminance comparing unit 41 sorts the luminance ratio for each partitioned area in increasing order.

The luminance comparing unit 41 acquires the average value of the 2nd to 4th lowest luminance ratios from among the luminance ratios for the partitioned areas sorted in increasing order as the aforesaid average luminance ratio C.

More specifically, the luminance comparing unit 41 acquires the average luminance ratio C by calculating equation (6) similarly to the first embodiment.

In the second embodiment, in equation (6), items Ct2 to Ct4 respectively denote the 2nd to 4th lowest luminance ratios.

For example, it is assumed that the lowest 4 luminance ratios from among the luminance ratios (P1=Y1′/Y1, P2=Y2′/Y2, P3=Y3′/Y3, . . . , P8=Y8′/Y8, . . . , P22=Y22′/Y22, . . . , P64=Y64′/Y64) of the entire partitioned areas are as follows.

The 64th (lowest) is Ct1=P1=Y1′/Y1;

the 63rd (2nd lowest) is Ct2=P2=Y2′/Y2;

the 62nd (3rd lowest) is Ct3=P8=Y8′/Y8; and

the 61st (4th lowest) is Ct4=P22=Y22′/Y22.

In this case, the average luminance ratio C is calculated in accordance with equation (7) similarly to the first embodiment.

In the above, a description has been given of the functional configuration to carry out the white balance processing of step S4 of FIG. 2 from the functional configuration of the image capturing apparatus 1 of FIG. 1 of the second embodiment with reference to FIGS. 3 and 4.

In the following, a description will be given of a detailed flow of the white balance processing of step S4 carried out by the image capturing apparatus 1 having such a functional configuration.

In the white balance processing, any of the white balance gain calculation unit 15, the image partitioning unit 16, and the luminance acquisition unit 17 executes the respective step processes, under the control of the CPU 11. In the following, however, descriptions of the control of the CPU 11 will be omitted.

FIG. 5 is a flowchart showing detailed flow of the white balance processing of step S4 from the flash light image capture processing of FIG. 2 carried out by the image capturing apparatus 1 of FIG. 1.

In step S31, the image partitioning unit 16 partitions the data of the live-view image without flash and the data of the image captured with flash respectively into 8 by 8 partitioned areas, and the luminance acquisition unit 17 acquires the luminance value of each partitioned area.

In step S32, the luminance comparing unit 41 calculates the luminance ratio of luminance values of the image captured with flash to values of the live-view image without flash for each partitioned area.

More specifically, the luminance comparing unit 41 calculates the above-mentioned equation (9) and thereby calculates the luminance ratio Pi for the i-th partitioned area. Such calculation of equation (9) is repeated for i=1 to 64, and the luminance ratios P1 to P64 are calculated.

In the present embodiment, the calculation result of equation (9) by the luminance comparing unit 41 is stored in the storing unit 24 and managed in the table format shown in FIG. 4, for example.

In step S33, the white balance gain calculation unit 15 sets the gain values of the RGB components for each partitioned area for the data of the live-view image without flash and the data of the image captured with flash.

In step S34, the white balance gain calculation unit 15 sets the area number i of the partitioned area to be processed to 1 (i=1). In the second embodiment, the partitioned area to be processed in the processes of steps S35 to S40, which will be described later, is selected in the order of the area number. As a result, the area number i for the partitioned area to be processed is firstly set to 1.

In step S35, the white balance gain calculation unit 15 determines whether or not the luminance ratio Pi exceeds the threshold value (Pi>threshold value).

In a case in which the luminance ratio Pi exceeds the threshold value, the partitioned area with area number i to be processed is regarded as an illuminated area. In such a case, a determination of YES is made in the process of step S35, and control proceeds to step S36.

In step S36, the white balance gain calculation unit 15 corrects the gain values of the RGB components of the partitioned area (illuminated area) with the area number i based on the luminance ratio Pi.

In this manner, control proceeds to step S41. The processes of step S41 and thereafter will be described later.

On the other hand, in a case in which the luminance ratio Pi does not exceed the threshold value, the partitioned area with the area number i to be processed is regarded as an unilluminated area. In such a case, a determination of NO is made in the process of step S35, and control proceeds to step S37.

The processes of steps S37 to S40 are executed as follows, and the gain values of the RGB components of the partitioned area with the area number i are corrected.

In step S37, the luminance comparing unit 41 calculates the average luminance ratio C based on the 2nd to 4th lowest luminance ratios from among the entire luminance ratios P1 to P64 calculated in the process of step S32.

More specifically, the average luminance ratio C is calculated in accordance with the above-mentioned equation (6).

Since it is sufficient if the process of step S37 is executed only once after NO is determined in the process of step S35 the first time, execution thereof may be omitted thereafter.

In step S38, the white balance gain calculation unit 15 converts the gain values of the RGB components of the partitioned area (unilluminated area) with the area number i from among the gain values set in the process of step S33 into the YUV converted values.

More specifically, the white balance gain calculation unit 15 acquires the YUV converted values of the partitioned area (unilluminated area) with the area number i in accordance with the above-mentioned equation (1).

In step S39, based on the average luminance ratio C acquired in the process of step S37, the white balance gain calculation unit 15 corrects the Y component value from among the YUV converted values of the partitioned area (unilluminated area) with area number i of the image captured with flash, and thereby calculates the weighted Y component value.

More specifically, the white balance gain calculation unit 15 corrects the Y component gain LY from among the YUV converted values of the partitioned area (unilluminated area) with area number i of the image captured with flash to the gain LY′, in accordance with the above-mentioned equation (3) using the average luminance ratio C calculated in the process of step S37 as a coefficient.

Thus, the Y component gain LY is corrected from among the YUV converted values of the partitioned area (unilluminated area) with area number i of the image captured with flash, in view of the overall luminance ratio, for the unilluminated areas, of the image captured with flash to the live-view image without flash, from among the partitioned areas thereof, and thereby the corrected Y component gain LY′ is acquired.

In step S40, the white balance gain calculation unit 15 inversely converts the weighted YUV converted values into the gain values of the RGB components of the partitioned area (unilluminated area) with area number i.

More specifically, the white balance gain calculation unit 15 acquires the inversely converted gain values of the RGB components of the partitioned area (unilluminated area) with area number i of the image captured with flash in accordance with the above-mentioned equation (4).

This means that the white balance gain calculation unit 15 inversely converts the YUV converted values (LY′, LU, LV) of the partitioned area (unilluminated area) with area number i of the image captured with flash, which has been weighted in the process of step S39, respectively into the R component gain (LRα), the G component gain (LGα), and the B component gain (LBα).

Thus, the gain values of the RGB components of the partitioned area with area number i of the image captured with flash are corrected in the process of step S36, in a case in which the partitioned area is an illuminated area (in a case in which YES is determined in the process of step S35), and are corrected in the processes of steps S37 to S40, in a case in which the partitioned area is an unilluminated area (in a case in which NO is determined in the process of step S35).

In this manner, control proceeds to step S41.

In step S41, the white balance gain calculation unit 15 increments the area number i by 1 (i=i+1).

In step S42, the white balance gain calculation unit 15 determines whether or not the area number i exceeds 64.

In a case in which the area number i does not exceed 64, i.e., there remains partitioned areas for which the gain values of the RGB components of the image captured with flash are not corrected, a determination of NO is made in step S42, control goes back to step S35, and the processes thereafter are repeated.

This means that the loop processing from steps S35 to S42 is executed for each of the partitioned areas with area number 1 to 64. Here, for a partitioned area classified as an illuminated area (a partitioned area for which YES is determined in the process of step S35), the gain values of the RGB components of the concerned partitioned area of the image captured with flash are corrected in the process of step S36. On the other hand, for a partitioned area classified as an unilluminated area (for which NO is determined in the process of step S35), the gain values of the RGB components of the concerned partitioned area of the image captured with flash are corrected in the processes of steps S37 to S40.

When the process of step S41 is executed for the final partitioned area, i.e., the partitioned area with area number 64, the area number i is incremented to 65, thereby exceeding 64. Therefore, YES is determined in the subsequent step S42, and control proceeds to step S43.

In step S43, the white balance gain calculation unit 15 sets the white balance of the image captured with flash for each partitioned area based on the gain values of the RGB components, which have been corrected in the process of step S36 for an illuminated area, and in the processes of steps S37 to S40 for an unilluminated area.

In this manner, the white balance processing is terminated. This means that the process of step S4 of FIG. 2 ends, and control proceeds to step S5.

As described above, the image capturing apparatus 1 is provided with a light emitting unit 21, an image capturing unit 20, a CPU 11, a white balance gain calculation unit 15, an image partitioning unit 16, a luminance acquisition unit 17, and a luminance comparing unit 41.

In response to a user operation, the CPU 11 executes control to cause the image capturing unit 20 to capture an image captured with flash, which is an image captured at a time when illuminated by light emitted from the light emitting unit 21, and a live-view image without flash, which is an image captured at a time when no light is emitted from the light emitting unit 21.

The white balance gain calculation unit 15 respectively calculates gain values of each color component for adjusting the white balances of the image captured with flash and the live-view image without flash, which have been set at the time of image capturing.

The image partitioning unit 16 partitions the image area captured by the image capturing unit 20 into a plurality of areas.

The luminance acquisition unit 17 calculates the luminance values of the plurality of areas partitioned by the image partitioning unit 16 respectively for the image captured with flash and the live-view image without flash.

The luminance comparing unit 41 calculates, as a relative value, a value acquired by dividing a luminance value of each area of the image captured with flash calculated by the luminance acquisition unit 17, by the luminance value of a corresponding area of the live-view image without flash.

The white balance gain calculation unit 15 specifies areas having relative values, which have been respectively calculated by the luminance comparing unit 41, not exceeding a predetermined value.

The luminance comparing unit 41 selects a plurality of relative values of lower values from among the calculated relative values.

The white balance gain calculation unit 15 corrects the gain values of each color component of the image captured with flash based on the calculated gain values of each color component of the image captured with flash and the live-view image without flash and the plurality of relative values selected by the luminance comparing unit 41.

In the image capturing apparatus 1 thus configured, it becomes possible to enhance natural color reproducibility of an image captured with a flash light.

Also, the white balance gain calculation unit 15 converts the acquired RGB components of the image captured with flash and the live-view image without flash into another color space, i.e., a set of pixel parameters (such as YUV converted values) including at least luminance information.

Furthermore, the white balance gain calculation unit 15 corrects the gain values of the RGB components based on the converted set of pixel parameters (YUV converted values).

In the image capturing apparatus 1 thus configured, since the luminance is adjusted in gray balance level by conversion into the YUV converted values, change in a specific color, caused when the luminance of an image captured with a flash light is separately adjusted for each color component thereof, no longer occurs, and it is possible to further enhance natural color reproducibility of an image.

It should be noted that the present invention is not limited to the embodiments described above, and modifications and improvements thereto within a scope that can realize an object of the present invention are included in the present invention.

In the embodiment described above, the luminance ratio Pi is acquired in accordance with the above-mentioned equation (9), but the present invention is not limited thereto. For example, the luminance ratio Pi may be acquired in accordance with the following equation (10). In this case, the 2nd to 4th highest luminance ratios are employed to calculate the average luminance ratio C.

$$\begin{matrix}[ Math . 10 ] & \\ Pi = \frac{Pi}{{Pi}^{′}} & ( 10 )\end{matrix}$$

Furthermore, in the embodiment described above, the 2nd to 4th lowest luminance ratios have been employed to calculate the average luminance ratio, but the present invention is not limited thereto. It is sufficient if the luminance ratios to be used to calculate the average luminance ratio are, at least, of relatively low values from among all luminance ratios.

Furthermore, in the embodiment described above, it has been described that the lowest luminance ratio is not used, but the present invention is not limited thereto. The lowest luminance ratio may also be employed as long as the lowest luminance ratio is not an unstable value such as an extremely low value in comparison with other luminance ratios.

Furthermore, in the embodiment described above, it has been described that the live-view image without flash and the image captured with flash are respectively partitioned into 64 (8 by 8) partitioned areas as shown in FIG. 3, but the present invention is not limited thereto. As long as the images are partitioned into a plurality of areas, the number, size, or the like of areas may be determined in any manner as appropriate.

Furthermore, in the embodiment described above, it has been described that the data of the image captured with flash and the live-view image without flash captured by the image capturing unit 20 is employed to execute the white balance processing, but the present invention is not limited thereto. For example, data of any captured image and any live-view image acquired from outside via the CPU 11 or the image processing unit 14 may be employed. Also, in the embodiment described above, it has been described that the data of the image captured with flash and the live-view image without flash is employed to execute the white balance processing, but the present invention is not limited thereto. For example, data of an image captured with flash and an image captured without flash may be employed to execute the white balance processing.

Furthermore, it has been described in the embodiments that an image capturing apparatus 1 such as a digital camera or the like is used as an example of the electronic apparatus, which the present invention is applicable to. However, the present invention is not limited thereto and can be applied to any electronic device that can carry out the white balance processing described above. More specifically, for example, the present invention can be applied to a notebook-sized personal computer, a video camera, a portable navigation device, a cell phone device, a portable game device, a web camera, and the like.

The series of processes described above can be executed by hardware and also can be executed by software. This means that the hardware configuration shown in FIG. 1 is merely an example, and the present invention is not limited thereto. More specifically, any type of function blocks may be employed to implement the above-described functions as long as the image capturing apparatus 1 can be provided with a function capable of implementing the entire series of processes, and accordingly, the functional blocks to be employed to implement the function are not limited to the example of FIG. 1. A single function block may be configured by a single piece of hardware, a single piece of software, or any combination thereof.

In a case in which the series of processes are to be executed by software, a program configuring the software is installed from a network or a storage medium into a computer or the like. The computer may be a computer embedded in dedicated hardware. Alternatively, the computer may be a computer capable of executing various functions by installing various programs, i.e., a general-purpose personal computer, for example.

The storage medium containing the program can be constituted not only by the removable media 31 shown in FIG. 1 distributed separately from the device main body for supplying the program to a user, but also can be constituted by a storage medium or the like supplied to the user in a state incorporated in the device main body in advance. The removable media 31 is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), or the like, for example. The magnetic optical disk is composed of an MD (Mini-Disk) or the like. The storage medium, supplied to the user in a state in which it is incorporated in the device main body in advance, may include the ROM 12 shown in FIG. 1 in which the program is stored, a hard disk included in the storing unit 24 shown in FIG. 1, or the like, for example.

It should be noted that in the present specification the steps describing the program stored in the storage medium include not only the processing executed in a time series following this order, but also processing executed in parallel or individually, which is not necessarily executed in a time series.

What is claimed is:

1. An image capturing apparatus comprising:
a light emitting unit;
an image capturing unit which captures a first image with light emitted by the light emitting unit and a second image, a luminance of the second image being lower than a luminance of the first image;
a first acquisition unit which acquires, for each of the first image and the second image, a gain value of a color component for adjusting a white balance;
a partitioning unit that partitions each of the first image and the second image into a plurality of areas;
a second acquisition unit which acquires a luminance value for each of the plurality of partitioned areas of the first image and a luminance value for each of the plurality of partitioned areas of the second image;
a calculation unit which calculates, for each of the plurality of partitioned areas, a relative value between the luminance value of one of the plurality of partitioned areas of the first image and the luminance value of one of the plurality of partitioned areas of the second image;
a selecting unit which selects a plurality of specific relative values from among the relative values calculated by the calculation unit, in a predetermined order of the specific relative values, wherein a number of the specific relative values which are selected is lower than a total number of the relative values calculated by the calculation unit; and
a correcting unit which corrects the gain value of the color component of the first image, based on (i) the gain value of the color component for each of the first image and the second image, and (ii) the plurality of specific relative values selected by the selecting unit.

2. The image capturing apparatus according to claim 1, wherein the correcting unit corrects the gain value of the color component of the first image such that the gain value of the color component of the first image is weighted by using (i) the gain value of the color component for each of the first image and the second image, and (ii) the plurality of specific relative values selected by the selecting unit.

3. The image capturing apparatus according to claim 1, wherein the gain value is a gain value of luminance.

4. The image capturing apparatus according to claim 1, wherein the selecting unit selects the plurality of specific relative values in decreasing order from among the relative values calculated by the calculation unit.

5. The image capturing apparatus according to claim 1, wherein the selecting unit selects the plurality of specific relative values in increasing order from among the relative values calculated by the calculation unit.

6. The image capturing apparatus according to claim 1, wherein the calculation unit calculates the relative value by dividing one of the luminance value of the one of the plurality of partitioned areas of the first image and the luminance value of the one of the plurality of partitioned areas of the second image by the other of the luminance value of the one of the plurality of partitioned areas of the first image and the luminance value of the one of the plurality of partitioned areas of the second image.

7. The image capturing apparatus according to claim 1, further comprising:
a conversion unit which converts each color component of the image acquired by the first acquisition unit into a set of pixel parameters including luminance information in another color space;
wherein the correcting unit corrects the gain value of each color component further based on (iii) the set of pixel parameters converted by the conversion unit.

8. The image capturing apparatus according to claim 1, further comprising:
a conversion unit which converts each color component of the image acquired by the second acquisition unit into a set of pixel parameters including luminance information in another color space;
wherein the correcting unit corrects the gain value of each color component further based on (iii) the set of pixel parameters converted by the conversion unit.

9. An image capturing method comprising:
capturing a first image with light emitted by a light emitting unit and a second image, a luminance of the second image being lower than a luminance of the first image;
acquiring, for each of the first image and the second image, a gain value of a color component for adjusting a white balance;
partitioning each of the first image and the second image into a plurality of areas;
acquiring a luminance value for each of the plurality of partitioned areas of the first image and a luminance value for each of the plurality of partitioned areas of the second image;
calculating, for each of the plurality of partitioned areas, a relative value between the luminance value of one of the plurality of partitioned areas of the first image and the luminance value of one of the plurality of partitioned areas of the second image;
selecting a plurality of specific relative values from among the calculated relative values, in a predetermined order of the specific relative values, wherein a number of the specific relative values which are selected is lower than a total number of the calculated relative values; and
correcting the gain value of the color component of the first image, based on (i) the gain value of the color component for each of the first image and the second image, and (ii) the selected plurality of specific relative values.

10. A non-transitory computer-readable storage medium having an image processing program stored thereon, the program being executable to control a computer to function as units comprising:
an image capturing unit which captures a first image with light emitted by a light emitting unit and a second image, a luminance of the second image being lower than a luminance of the first image;
a first acquisition unit which acquires, for each of the first image and the second image, a gain value of a color component for adjusting a white balance;
a partitioning unit that partitions each of the first image and the second image into a plurality of areas;
a second acquisition unit which acquires a luminance value for each of the plurality of partitioned areas of the first image and a luminance value for each of the plurality of partitioned areas of the second image;
a calculation unit which calculates, for each of the plurality of partitioned areas, a relative value between the luminance value of one of the plurality of partitioned areas of the first image and the luminance value of one of the plurality of partitioned areas of the second image;
a selecting unit which selects a plurality of specific relative values from among the relative values calculated by the calculation unit, in a predetermined order of the specific relative values, wherein a number of the specific relative values which are selected is lower than a total number of the relative values calculated by the calculation unit; and
a correcting unit which corrects the gain value of the color component of the first image, based on (i) the gain value of the color component for each of the first image and the second image, and (ii) the plurality of specific relative values selected by the selecting unit.
